(19) United States
(12) Patent Application Publication
(10) Pub. No.: US 2023/0029365 A1
(43) Pub. Date: Jan. 26, 2023

(54) SILICONE PARTICLES WITH A CROSS-LINKED CORE AND PREPARATION THEREOF

(71) Applicant: Wacker Chemie AG, Munich (DE)

(72) Inventor: Sebastian KNÖR, Emmerting (DE)

(73) Assignee: Wacker Chemie AG, Munich (DE)

(21) Appl. No.: 17/785,057

(22) PCT Filed: Dec. 17, 2019
(86) PCT No.: PCT/EP2019/085649

§ 371 Date: Jun. 14, 2022

(51) Int. Cl. C08L 83/04; C08J 3/12

(52) U.S. Cl. CPC C08L 83/04; C08J 3/128; C08J 2383/04; C08J 2483/04

(57) ABSTRACT

Particles P and methods of making the same. The particles P are composed of a core K comprising crosslinked silicone elastomer composition X and of a shell H of silica S. Where the core K includes a reinforcing filler F which is selected from pyrogenic or precipitated hydrophobic silicas having DIN 66131 BET surface areas of at least 50 m²/g and also from carbon blacks and activated carbons and silicone resins.

The invention relates to elastomeric particles P, composed of a core comprising crosslinked silicone elastomer composition and reinforcing filler, and to a method for producing them.

WO2017142068 A1 describes the advantageous properties of silica-coated silicone elastomer particles, especially spherical properties, possibility of influencing the hydrophobic properties, friction-reducing properties, and absence of blocking. Silica-coated silicone elastomer particles of this kind therefore find applications in cosmetics.

Such particles also have the advantage of being able to absorb functional substances, such as care oils or fragrances. This is a substantial advantage over the resin-based particles disclosed in WO2007113095. These particles according to WO2017142068, however, have a skinfeel which is still not ideal and a low mechanical stability. Pressure and friction easily destroy such elastomer particles.

The invention provides particles P composed of a core K containing crosslinked silicone elastomer composition X and reinforcing filler F and of a shell H of silica S.

Under application conditions the particles P have a a surprisingly improved skinfeel relative to the known particles having no reinforcing filler in the core. This is especially surprising since the reinforcing filler is contained in the core K of the silica-coated silicone elastomer particles and does not modify the outer shell H of the particle P, that shell producing the immediate skinfeel.

Entirely unforeseeably, the particles P of the invention also have an improved mechanical stability relative to known particles which in the core have no reinforcing filler or a non-reinforcing filler, despite the fact that the outer shell H of the particle P is unchanged.

The particles P are substantially spherical. With preference the sphericity SPHT3 is at least 0.8, more preferably at least 0.82, as determinable by ISO 9276-6 using a Camsizer X2 from Retsch Technology.

The particles P are characterized in particular in that the silica S used are bonded substantially on the surface of the polymer particles P. The distribution of the silica S used can be obtained from TEM micrographs of thin sections of embedded particles of the invention. Silica S is immersed preferably more than 10 nm, more preferably more than 20 nm, very preferably more than 30 nm into the crosslinked polymerization product, and protrudes preferably more than 10 nm, more preferably more than 20 nm, very preferably more than 30 nm from the crosslinked polymerization product, in each case measured from the outer boundary of the crosslinked polymerization product, and so is firmly bonded on the surface of particle P. This is a substantial advantage over a commercially available product wherein the completed silicone elastomer particle is aftertreated with a silica. In the case of such a product, the silica is not immersed into the silicone elastomer and hence is not firmly bonded on the surface.

As the silicone elastomer composition X it is possible in principle to use all silicones known from the prior art. Addition-crosslinking, peroxidically crosslinking, condensation-crosslinking or radiation-crosslinking compositions may be used. Peroxidically or addition-crosslinking components are preferred. Addition-crosslinking compositions are particularly preferred.

Addition-crosslinking silicone elastomer compositions X used in the invention are known in the prior art and in the simplest case comprise
(A) at least one linear compounds which contains radicals with aliphatic carbon-carbon multiple bonds,
(B) at least one linear organopolysiloxane compound with Si-bonded hydrogen atoms,
or, instead of (A) and (B),
(C) at least one linear organopolysiloxane compound which contains SiC-bonded radicals with aliphatic carbon-carbon multiple bonds and Si-bonded hydrogen atoms, and
(D) at least one hydrosilylation catalyst.

The addition-crosslinking silicone elastomer compositions X may be one-component silicone compositions and also two-component silicone compositions.

In the case of two-component silicone elastomer compositions X, the two components of the addition-crosslinking silicone elastomer compositions X may comprise all the constituents in any desired combination, generally with the proviso that one component does not simultaneously contain siloxanes with aliphatic multiple bond, siloxanes with Si-bonded hydrogen, and catalyst, that is, essentially, does not simultaneously contain the constituents (A), (B) and (D) or (C) and (D).

The compounds (A) and (B) or (C) used in the addition-crosslinking silicone elastomer compositions X are selected, as is known, such that crosslinking is possible. Thus, for example, compound (A) contains at least two aliphatically unsaturated radicals and (B) contains at least three Si-bonded hydrogen atoms, or compound (A) contains at least three aliphatically unsaturated radicals and siloxane (B) contains at least two Si-bonded hydrogen atoms, or else, instead of compound (A) and (B), siloxane (C) is used which contains aliphatically unsaturated radicals and Si-bonded hydrogen atoms in the proportions stated above. Also are mixtures of (A) and (B) and (C) with the above-stated proportions of aliphatically unsaturated radicals and Si-bonded hydrogen atoms.

The addition-crosslinking silicone elastomer composition X contains typically 30-99.9 wt %, preferably 35-95 wt % and more preferably 40-90 wt % of (A). The addition-crosslinking silicone elastomer composition X contains typically 0.1-60 wt %, preferably 0.5-50 wt % and more preferably 1-30 wt % of (B). If the addition-crosslinking silicone elastomer composition X comprises component (C), typically 30-95 wt %, preferably 35-90 wt %, more preferably 40-85 wt % of (C) is present in the formulation.

The compound (A) used in the invention may comprise silicon-free organic compounds having preferably at least two aliphatically unsaturated groups and also organosilicon compounds having preferably at least two aliphatically unsaturated groups, or else mixtures thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisoproppenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methylhepta-(1,5)-diene, 3-phenylhexa-(1,5)-diene, 3-vinylhexa-(1,5)-diene and 4,5-dimethyl-4,5-diethylocta-(1,7)-diene, N,N′-methylenebisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallyl urea, triallylamine, tris(2-methylallyl)amine, 2,4,6-triallyloxy-1,3,5-triazine, triallyl-s-triazine-2,4,6(1H,3H,5H)-trione, diallylmalonic esters, polyethylene glycol diacrylate, polyethylene glycol dimethacrylate, poly(propylene glycol) methacrylate.

The addition-crosslinking silicone elastomer compositions X preferably comprise as constituent (A) at least one aliphatically unsaturated organosilicon compound, in which case it is possible to use all aliphatically unsaturated organosilicon compounds used to date in addition-crosslinking components, such as, for example, silicone block copolymers with urea segments, silicone block copolymers with amide segments and/or imide segments and/or ester-amide segments and/or polystyrene segments and/or silarylene segments and/or carborane segments, and silicon graft copolymers with ether groups.

As organosilicon compounds (A) containing SiC-bonded radicals with aliphatic carbon-carbon multiple bonds, preference is given to using linear or branched organopolysiloxanes composed of units of the general formula (I)

R⁴ₐR⁵_{b}SiO_{(4-a-b)/2} (I)

where
R⁴ independently at each occurrence, identical or different, is an organic or inorganic radical free from aliphatic carbon-carbon multiple bonds,
R⁵ independently at each occurrence, identical or different, is a monovalent, substituted or unsubstituted, SiC-bonded hydrocarbon radical with at least one aliphatic carbon-carbon multiple bond,
a is 0, 1, 2 or 3, and
b is 0, 1 or 2,
   with the provision that the sum of a+b is less than or equal to 3 and there are at least 2 radicals R⁵ per molecule.

Radical R⁴ may comprise monovalent or polyvalent radicals, in which case the polyvalent radicals such as divalent, trivalent and tetravalent radicals, for example, join two or more, such as two, three or four, for instance, siloxy units of the formula (I) to one another.

Other examples of R⁴ are the monovalent radicals —F, —Cl, —Br, OR⁶, —CN, —SCN, —NCO, and SiC-bonded, substituted or unsubstituted hydrocarbon radicals which may be interrupted by oxygen atoms or by the group —C(O)—, and also divalent radicals Si-bonded at both ends in accordance with formula (I). Where radical R⁴ comprises SiC-bonded, substituted hydrocarbon radicals, preferred substituents are halogen atoms, phosphorus-containing radicals, cyano radicals, —OR⁶, —NR⁶—, —NR⁶₂, —NR⁶—C(O)—NR⁶₂, —C(O)—NR⁶₂, —C(O)R⁶, —C(O)OR⁶, —SO₂-Ph and —C₆F₅. In these radicals, R⁶, independently at each occurrence, identical or different, is a hydrogen atom or a monovalent hydrocarbon radical having 1 to 20 carbon atoms, and Ph is the phenyl radical.

Examples of radicals R⁴ are alkyl radicals, such as the methyl, ethyl, n-propyl, isopropyl, n-butyl, isobulyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl and methylcyclohexyl radicals, aryl radicals, such as the phenyl, naphthyl, anthryl and phenanthryl radical, alkaryl radicals, such as o-, m-, p-tolyl radicals, xylyl radicals and ethylphenyl radicals, and aralkyl radicals, such as the benzyl radical, the α- and the β-phenylethyl radical.

Examples of substituted radicals R⁴ are haloalkyl radicals, such as the 3,3,3-trifluoro-n-propyl radical, the 2,2,2,2′,2′,2′-hexafluoroisopropyl radical, the heptafluoroisopropyl radical, haloaryl radicals, such as the o-, m- and p-chlorophenyl radical, —(CH₂)—N(R⁶)C(O)NR⁶₂, —(CH₂)ₒ—C(O)NR⁶₂, —(CH₂)ₒ—C(O)R⁶, —(CH₂)ₒ—C(O)OR⁶, —(CH₂)ₒ—C(O)NR⁶₂, —(CH₂)—C(O)—(CH₂)ₚC(O)CH₃, —(CH₂)—O—CO—R⁶, —(CH₂)—NR⁶—(CH₂)ₚ—NR⁶₂, —(CH₂)ₒ—O—(CH₂)ₚCH (OH) CH₂OH, —(CH₂)ₒ(OCH₂CH₂)ₚOR⁶, —(CH₂)ₒ—SO₂-Ph and —(CH₂)ₒ—O—C₆F₅, where R⁶ and Ph corresponds to the definition indicated for them above, and o and p are identical or different integers between 0 and 10.

Examples of R⁴ as divalent radicals Si-bonded at both ends in accordance with formula (I) are radicals which derive from the monovalent examples stated above for radical R⁴ in that there is additional bonding through substitution of a hydrogen atom; examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)ₒ—C₆H₄—(CH₂)ₒ, —(CH₂)ₒ—C₆H₄—(CH₂)ₒ—, —(CH₂O)ₚ, (CH₂CH₂O)ₒ, —(CH₂)ₒ—Oₓ—C₆H₄—SO₂—C₆H₄—Oₓ—(CH₂)ₒ—, where x is 0 or 1, and Ph, o and p have the definition stated above.

Radical R⁴ preferably comprises a monovalent, SiC-bonded, optionally substituted hydrocarbon radical which is free from aliphatic carbon-carbon multiple bonds and has 1 to 18 carbon atoms, more preferably a monovalent, SiC-bonded hydrocarbon radical which is free from aliphatic carbon-carbon multiple bonds and has 1 to 6 carbon atoms, more particularly the methyl or phenyl radical.

Radical R⁵ may comprise any desired groups which are amenable to an addition reaction (hydrosilylation) with an SiH-functional compound.

Where radical R⁵ comprises SiC-bonded, substituted hydrocarbon radicals, preferred substituents are halogen atoms, cyano radicals and —OR⁶, wherein R⁶ has the definition stated above.

Radical R⁵ preferably comprises alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, particular preference being given to the use of vinyl, allyl and hexenyl radicals.

The molecular weight of the constituent (A) may vary within wide limits, for instance between 10² and 10⁶ g/mol. Hence, for example, the constituent (A) may be an alkenyl-functional oligosiloxane of relatively low molecular weight, such as 1,2-divinyltetramethyldisiloxane, or alternatively a high-polymer polydimethylsiloxane, with a molecular weight, for example, of 10⁵ g/mol (number average determined via nmR), which possesses Si-bonded vinyl groups in the chain or at the ends. The structure of the molecules forming the constituent (A) as well is not fixed; in particular the structure of a siloxane of relatively high molecular weight—that is, an oligomeric or polymeric siloxane—may be linear, cyclic, branched or else resinous, networklike. Linear and cyclic polysiloxanes are composed preferably of units of the formula R⁴₃SiO_{1/2}, R⁵R⁴₂SiO_{1/2}, R⁵R⁴SiO_{1/2} and R⁴₂SiO_{2/2}, where R⁴ and R⁵ have the definition indicated above. Branched and networklike polysiloxanes additionally comprise trifunctional and/or tetrafunctional units, preference being given to those of the formula R⁴SiO_{3/2}, R⁵SiO_{3/2} and SiO_{4/2}. It is of course also possible to use mixtures of different siloxanes satisfying the criteria of constituent (A).

Particularly preferred as component (A) is the use of vinyl-functional, substantially linear polydiorganosiloxanes having a DIN 53019 kinematic viscosity of 0.01 to 500 000 mm²/s, more preferably of 0.1 to 100 000 mm²/s, especially preferably of 1 to 10000 mm²/s, measured in each case at 25° C.

As organosilicon compound (B) it is possible to use all hydrogen-functional organosilicon compounds which have also been used to date in addition-crosslinkable compositions.

As organopolysiloxanes (B) which contain Si-bonded hydrogen atoms, preference is given to using linear, cyclic or branched organopolysiloxanes composed of units of the general formula (III)

R⁴_{c}H_{d}SiO_{(4-c-d)/2} (III)

where
R⁴ has the definition indicated above,
c is 0.1 2 or 3, and
d is 0, 1 or 2,
   with the proviso that the sum of c+d is less than or equal to 3 and there are at least two Sibonded hydrogen atoms per molecule.

The organopolysiloxane (B) used in the invention preferably comprises Si-bonded hydrogen in the range from 0.04 to 1.7 percent by weight (wt %), based on the total weight of the organopolysiloxane (B).

The molecular weight of the constituent (B) may likewise vary within wide limits, for instance between 10² and 10⁶ g/mol. Thus, for example, the constituent (B) may be an SiH-functional oligosiloxane of relatively low molecular weight, such as tetramethyldisiloxane, or alternatively a high-polymer polydimethylsiloxane possessing SiH groups in the chain or at the ends, or a silicone resin containing SiH groups.

The structure of the molecules forming the constituent (B) as well is not fixed; in particular the structure of an SiH-containing siloxane of relatively high molecular weight—that is, an oligomeric or polymeric SiH-containing siloxane—may be linear, cyclic, branched or else resinous, networklike. Linear and cyclic polysiloxanes (B) are composed preferably of units of the formula R⁴₃SiO_{1/2}, HR⁴₂SiO_{1/2}, HR⁴SiO_{2/2} and R⁴₂SiO_{2/2}, where R⁴ has the definition indicated above. Branched and networklike polysiloxanes additionally comprise trifunctional and/or tetrafunctional units, with preference being given to those of the formulae R⁴SiO_{3/2}, HSiO_{3/2} and SiO_{4/2}, where R⁴ has the definition indicated above.

It is of course also possible to use mixtures of different siloxanes satisfying the criteria of constituent (B). Particularly preferred is the use of low molecular weight, SiH-functional compounds such as tetrakis(dimethylsiloxy)silane and tetramethylcyclotetrasiloxane, and also of higher-molecular-weight, SiH-containing siloxanes, such as poly(hydrogenmethyl)siloxane and poly(dimethylhydrogenmethyl)siloxane having a DIN 53019 kinematic viscosity at 25° C. of 1 to 20 000 mm²/s, preferably of 10 to 1000 mm²/s, or analogous SiH-containing compounds in which some of the methyl groups have been replaced by 3,3,3-trifluoropropyl or phenyl groups.

Constituent (B) is preferably present in the crosslinkable silicone elastomer compositions X in an amount such that the molar ratio of SiH groups to aliphatically unsaturated groups from (A) is 0.1 to 20, more preferably between 0.3 and 5.0 and especially preferably between 0.6 and 2.

The components (A) and (B) used in the invention are commercially customary products and/or are preparable by methods which are common in chemistry.

Instead of components (A) and (B), the silicone elastomer compositions may comprise organopolysiloxanes (C) which at the same time contain aliphatic carbon-carbon multiple bonds and Si-bonded hydrogen atoms. It is also possible for the silicone elastomer compositions X to comprise all three components (A), (B) and (C).

Siloxanes (C), if used, are preferably those composed of units of the general formulae (IV), (V) and (VI)

R⁴_{f}SiO_{4/2} (IV)

R⁴_{g}R⁵SiO_{3-g/2} (V)

R⁴ₕHSiO_{3-h/2} (VI)

where

R⁴ and R⁵ have the definition indicated for them above

f is 0, 1, 2 or 3,

g is 0, 1 or 2 and

h is 0, 1 or 2,

with the proviso that there are at least 2 radicals R⁵ and at least 2 Si-bonded hydrogen atoms per molecule.

Examples of organopolysiloxanes (C) are those composed of SO_{4/2}, R⁴₃SiO_{1/2}, R⁴₂R⁵SiO_{1/2} and R⁴₂HSiO_{1/2} units, known as MP resins, it being possible for these resins additionally to contain R⁴SiO_{3/2} and R⁴₂SiO units, and also linear organopolysiloxanes substantially consisting of R⁴₂R⁵SiO_{1/2}, R⁴₂SiO and R⁴HSiO units where R⁴ and R⁵ have the definition stated above.

The organopolysiloxanes (C) preferably possess an average DIN 53019 kinematic viscosity of 0.01 to 500 000 mm²/s, more preferably of 0.1 to 100 000 mm²/s, especially preferably of 1 to 10000 mm²/s, measured in each case at 25° C. Organopolysiloxanes (C) are preparable by techniques which are common in chemistry.

As hydrosilylation catalyst (D) it is possible to use all catalysts known to the prior art. Component (D) may be a platinum-group metal, for example platinum, rhodium, ruthenium, palladium, osmium or iridium, an organometallic compound, or a combination thereof. Examples of component (D) are compounds such as hexachloroplatinic(IV) acid, platinum dichloride, platinum acetylacetonate, and complexes of said compounds which are encapsulated in a matrix or in a structure of core-shell type. The low molecular weight platinum complexes of the organopolysiloxanes include 1,3-diethenyl-1,1,3,3-tetramethyldisiloxane complexes with platinum. Other examples are platinum phosphite complexes or platinum phosphine complexes. For photocuring or UV-curing compositions it is possible, for example, to use alkylplatinum complexes such as derivates of cyclopentadienyltrimethylplatinum(IV), cyclooctadienyldimethylplatinum(II) or diketonato complexes such as, for example, bisacetylacetonatoplatinum(II), in order to initiate the addition reaction by means of light. These compounds may be encapsulated in a resin matrix.

Component D is preferably used in a concentration of 0.1 to 1000 parts per million (ppm), more preferably of 0.5 to 100 ppm and especially preferably of 1 to 25 ppm, based in each case on the weight of the platinum-group metal and crosslinkable silicone elastomer composition X.

The cure rate may be low if the constituent of the platinum-group metal is present at below 1 ppm. The use of more than 100 ppm of the platinum-group metal is uneconomic or reduces the storage stability of the silicone elastomer composition X. The reinforcing filler F is preferably selected from pyrogenic or precipitated hydrophobic silicas having BET surface areas of at least 50 m²/g and also from carbon blacks and activated carbons, such as furnace black and acetylene black, and silicone resins, preference being given to silicone resins F and pyrogenic and precipitated hydrophobic silicas having DIN 66131 and DIN 66132 (determined with nitrogen) BET surface areas of at least 50 m²/g, or mixtures thereof, as reinforcing fillers F.

Examples of silicone resins F are MQ, MT, MDQ, MDT, MTQ and MDTQ silicone resins, where M is selected from R₃SiO_{1/2} and HR₂SiO_{1/2} and R¹R₂SiO_{1/2}, D is selected from R¹RSiO_{1/2} and R₂SiO_{1/2} and HRSiO_{1/2}, T is selected from RSiO_{3/2} and R¹SiO_{3/2} and HSiO_{3/2}, and Q comprises SiO_{4/2} units, where R has the the above-described definitions of R⁴, and R¹ has the definitions of R⁵.

Preferred pyrogenic and precipitated hydrophobic silicas have a DIN 66131 and DIN 66132 BET surface area of between 50 and 800 m²/g, more preferably between 100 and 500 m²/g and especially preferably between 150 and 400 m²/g. Particular preference is given to using pyrogenic hydrophobic silicas having BET surface areas of between 150 and 400 m²/g as solids F.

The reinforcing solid F is preferably surface-treated and consequently hydrophobic. Preferred solids F owing to surface treatment have a carbon content of at least 1.5 to not more than 20 wt %, preferably between 1.8 and 10 wt %, more preferably between 2 to 8 wt %. Particularly preferred is surface-treated silica containing 3 to 6 wt % of Si-bonded, aliphatic groups. These groups are, for example, Si-bonded methyl or vinyl groups. Hydrophobic silicas suitable as solid F are characterized in that they are substantially not wettable with water. This means in the invention that the methanol number of the solid F is greater than 40, preferably greater than 50.

Hydrophobized silicas have long been known to the skilled person. The solid F may be hydrophobized in a separate operating step or else hydrophobized in the form of an in situ hydrophobization, by addition of a suitable hydrophobizing agent to the silicone elastomer composition X. Techniques for the surface treatment and hydrophobization of silicas are known to the skilled person. Hydrophobization may take place, preferably, by means of halogen-free silanes, as described in EP1433749A1, for example.

Example of commercially available hydrophobic silicas are HDK® H18 and HDK® H20 loaded with the moiety —[Si(CH₃)₂—O]n, HDK® H2000 loaded with the moiety —O—Si(CH3)3 (available commercially from Wacker Chemie AG, Munich) and AEROSIL® 972 and AEROSIL® 805 (available commercially from Evonik Degussa GmbH, Frankfurt am Main).

In one preferred embodiment, solid F comprises silicone resins F, more particularly an MDT or an MQ resin, preferably an MQ resin. Preferred MQ resins contain less than 10 mol %, preferably less than 2 mol %, especially preferably less than 0.5 mol % of D or T units. Especially preferred MQ resins are substantially free from D or T units.

The silicone resin F is preferably solid at 25° C. under the pressure of the surrounding atmosphere, i.e. 1013 hPa.

The silicone resins F are preferably resins having a molecular weight Mw of at least 500, preferably at least 900, more preferably at least 1200, and at most 15000, preferably at most 10000, more preferably at most 8000, with the polydispersity being at most 20, preferably at most 18, more preferably at most 16, more particularly at most 15.

Molecular weight distributions:

Molecular weight distributions are determined as weight average Mw and as number average Mn, employing the technique of gel permeation chromatography (GPC or Size Exclusion Chromatography (SEC)) with polystyrene standard and refractive index detector (RI detector). Unless otherwise designated, THF is used as eluent and DIN 55672-1 is employed. The polydispersity is the ratio Mw/Mn.

Preferred silicone resins F contain at least 1 mol %, preferably at least 2 mol %, of units selected from R¹R₂SiO_{1/2}, R¹RSiO_{1/2} and R¹SiO_{3/2} units, preferably R¹R₂SiO_{1/2} units.

The silicone resins F preferably contain 0.1 to 10 wt %, more preferably 0.5 to 8 wt %, very preferably 1 to 6 wt % of alkoxy groups as radical R. Particularly suitable and therefore preferred are methoxy, ethoxy, isopropoxy and tert-butoxy radicals.

Preferred radicals R are saturated aliphatic groups, preferably the methyl, ethyl and isooctyl group, more preferably methyl.

Preferred radicals R¹ are unsaturated aliphatic groups, preferably vinyl groups.

Especially preferred as filler F are MQ resins containing vinyl groups and containing 45 to 65 mol %, preferably 50 to 60 mol %, of Q units and 30 to 50 mol %, preferably 35 to 45 mol %, of M units of the form R₃SiO_{1/2}, and 2 to 10 mol %, preferably 3 to 8 mol %, of M units of the form R¹R₂SiO_{1/2}, where R is preferably methyl and R¹ is preferably vinyl.

In the crosslinkable silicone elastomer compositions X the reinforcing filler F is used preferably as individual fillers F or likewise preferably as a mixture of two or more fillers F.

The silicone elastomer composition X together with the reinforcing filler F forms the mixture B.

The mixture B contains preferably 5 to 200 parts by weight, more preferably 10 to 100 parts by weight, especially preferably 15 to 50 parts by weight of reinforcing filler F per 100 parts by weight of the crosslinkable silicone elastomer composition X.

As well as the reinforcing filler F, the mixture B may also comprise nonreinforcing fillers. Examples of nonreinforcing fillers are fillers having a BET surface area of up to 50 m²/g, such as quartz, diatomaceous earth, calcium silicate, zirconium silicate, zeolites, metal oxide powders, such as aluminum oxides, titanium oxides, iron oxides or zinc oxides and/or their mixed oxides, barium sulfate, calcium carbonate, gypsum, silicon nitride, silicon carbide, boron nitride, glass powders and plastics powders.

Additionally to at least one siloxane or silane, the droplets may further constituents B selected from catalysts, fillers, inhibitors, heat stabilizers, solvents, plasticizers, color pigments, sensitizers, photoinitiators, adhesion promoters, etc.

Silica S preferably comprises partly water-wettable pyrogenic and precipitated silicas or mixtures thereof, having a specific BET surface area of 30 to 500 m²/g, more preferably 100 to 300 m²/g, with pyrogenic silica being particularly preferred. The BET surface area is measured according to known methods, preferably in accordance with Deutsche Industrie Norm [German Industry Standard] DIN 66131 and DIN 66132.

Silica S is preferably surface-treated with a suitable hydrophobizing agent and is hydrophobic as a result. The hydrophobization is to be performed such that the silica S is still partly wettable with water. This means in the invention that the methanol number of the silica S is less than 40, preferably less than 30. Preferred silicas S, owing to surface treatment, have a carbon content of at least 0.2 to not more than 1.5 wt %, preferably between 0.4 and 1.4 wt %, more preferably between 0.6 to 1.3 wt %. The hydrophobic groups are, for example, Si-bonded methyl or vinyl groups. Hydrophobization techniques for silicas are known to the skilled person.

Preferred as silica S are silanized pyrogenic silicas having a methanol number of less than 30.

Especially preferred are partly water-wettable silicas as described in EP 1433749 A1 and DE 10349082 A1.

The mean particle size of the particulate solid F or, where appropriate, aggregates of the particles is preferably less than the mean diameter d₅₀ of the droplets without the finely divided particles.

The mean particle size of the particulate solid F is less than 1000 nm, preferably between 10 nm and 800 nm, more preferably between 50 nm and 500 nm and very preferably between 75 nm and 300 nm, measured in each case as the mean hydrodynamic equivalent diameter by means of photon correlation spectroscopy in 173° backscatter using a Nanosizer ZS from Malver.

For the determination of the methanol number, defined mixtures of water with methanol are prepared, and then the surface tensions of these mixtures are determined using known techniques. In a separate experiment, these water-methanol mixtures are overlaid with defined amounts of particles and shaken under defined conditions (for example, gentle shaking with the hand or with a tumble mixer for around 1 minute). Determinations are made of the water-alcohol mixture for which the particles just still do not sink in, and of the water-alcohol mixture with higher alcohol content for which the particles just sink in. The surface tension of the latter alcohol-water mixture furnishes the critical surface energy γ_{crit} as a measure of the surface energy y of the particles. The methanol content in water gives the methanol number.

The reinforcing filler F is preferably more hydrophobic than the silica S.

The particles P preferably have a size ×50 of 1 to 100 □m, preferably of 2 to 50 □m, more preferably of, in particular, 3 to 20 □m, more particularly of 3 to 8 □m.

The particles P are amphiphilic, meaning that they are both hydrophilic (i.e. water-loving) and lipophilic (i.e. fat-loving). This means that the particles P are readily dispersible not only in polar solvents, such as water or alcohols, for example, but also in apolar solvents, such as aliphatic hydrocarbons, for example, or polydimethylsiloxane oils, without addition of further dispersing assistants or additives, such as organic emulsifiers or other surface-active substances, for example. This is a substantial advantage of the particles P in comparison to uncoated silicone elastomer particles, which are very hydrophobic and which are not dispersible in polar solvents, such as water or alcohols, for example, without the use of unwanted auxiliaries, such as organic emulsifiers. In the case of in the case of the particles P, the silica S is firmly bonded on the surface, and consequently the amphiphilic properties are retained on dispersion in a solvent. This is a substantial advantage relative to silicone elastomer particles according to the prior art, which after curing are aftertreated with silica, since in the case of such particles, not in accordance with the invention, the absorbed silica is not permanently bonded. A disadvantage of these particles according to the prior art is that impermanently bonded silica is detached wholly or partly on dispersing of the particles in a solvent, causing the particles to become highly hydrophobic and making them no longer dispersible in polar solvents, such as water, for example.

Further provided by the invention is a method for producing the particles P, composed of a core K comprising crosslinked silicone elastomer composition X and reinforcing filler F and a shell H of silica S, wherein, in a first step, a dispersion A comprising silica S and water is mixed with a mixture B comprising crosslinkable silicone elastomer composition X and reinforcing filler F, to give a continuous phase containing water and a discontinuous phase containing crosslinkable silicone elastomer composition X and reinforcing filler F, and in a second step the discontinuous phase is crosslinked, to give the particles P.

There is no alteration of the continuous phase in the course of the crosslinking in the second step.

The continuous phase preferably comprises at least 80 wt %, more particularly at least 90 wt %, of water.

A three-phase mixture is preferably formed, in which a emulsions of sparingly water-soluble and of water-immiscible silicone elastomer composition X, stabilized in the water phase by means of partly hydrophobized silicas (Pickering emulsions). The silicone elastomer composition X is crosslinked, in a method suitable for producing particles P, after the emulsification. It may be necessary to hydrolyze condensable silicone elastomer composition X, if they comprise, for example, alkoxy- or acetoxy-substituted silanes or siloxanes. If silicone compositions X are sufficiently reactive, the water present is enough to bring about, optionally, the hydrolysis and subsequently the condensation. In the case of less reactive silicone elastomer compositions X, catalysts are required, which bring about, optionally, the hydrolysis and the condensation of the siloxanes and silane. These catalysts may be acids and may be bases or else metal catalysts, such as group IV transition metal catalysts, tin catalysts, of the kind typically used to accelerate hydrolyses, condensation reactions or transesterification reactions. Suitable acids or base, besides the known mineral acids and metal salts, include acidic or basic silanes or siloxanes.

Preferred basic catalysts are NaOH, KOH, ammonia and NEt₃.

Preferred acidic catalysts are p-toluenesulfonic acid, aqueous or gaseous HCl, sulfuric acid.

If the method comprises a polymerization reaction, that reaction may be, for example, a radical polymerization reaction of an olefinically unsaturated siloxane or silane.

In one particular embodiment, transition metal catalysts, such as platinum catalysts, for example, are added to the mixture B, especially when it comprises siloxanes capable of reacting with one another in a hydrosilylation reaction.

The method is to be performed in the second step in such a way that the silicas S stabilizing the discontinuous phase react during the crosslinking with the surface of the mixture B forming the cores, or at least enter into a stable interaction with said surface, such as hydrogen bonds, van der Waals interactions or another directive interaction, or else a combination of such directive interactions, so that the silicas S are anchored permanently on the cores formed from the mixture B.

The size of the particles P may be controlled, for example, through the emulsifying technology—that is, for instance, through variables such as the shearing energy introduced, the volume fraction of the mixture B, the amount of the silicas S, the pH of the continuous water phase and its ionic strength, the viscosity, the metering sequence, the metering rate, or through the reaction regime—that is, for example, through the reaction temperature, the reaction time, the concentrations of the raw materials used. The selection and the amount of any hydrolysis and condensation catalyst used likewise have an effect on the particle size.

When emulsifying technology which allows the production of relatively small droplets is used, this method results in small, surface-structured particles P. For this purpose it is possible, for example, to use different shearing energies or a selection of different silicas S for stabilizing the mixture B in water.

With preference the reinforcing filler F and optional nonreinforcing fillers or optional further constituents are mixed homogeneously with the silicone elastomer composition X in a first step, before in a further step the mixture B is emulsified with dispersion A and subsequently crosslinked to form the particle P. This ensures that all of the fillers and optional further constituents are located as part of the mixture B, after emulsification, in the interior of the droplets, and after crosslinking are located in the interior of the core K of the particles P.

The Pickering emulsions E of the mixture B are preferably substantially free from conventional liquid and solid, organic, surface-active substances which are nonparticulate at room temperature and under the pressure of the surrounding atmosphere, such as nonionic, cationic and anionic emulsifiers (“organic emulsifiers”).

Organic emulsifiers here refers not to particles and colloids, but instead to molecules and polymers, in line with the definition of molecules, polymers, colloids and particles as given in Dispersionen and Emulsionen [Dispersions and Emulsions], G. Lagaly, O. Schulz, R. Zindel, Steinkopff, Darmstadt 1997, ISBN 3-7985-1087-3, pp. 1-4. In general these organic emulsifiers have a size of less than 1 nm, a molar mass <10 000 g/mol, a carbon content >50 wt %, determinable by elemental analysis, and a Mohs hardness of less than 1.

At the same time the organic emulsifiers from which the emulsions of the invention are substantially free usually have a solubility in water at 20° C. and of the pressure of the surrounding atmosphere, i.e., 900 to 1100 hPa, homogeneously or in micelle form, of greater than 1 wt %.

The Pickering emulsions E of the mixture B may comprise such organic emulsifiers up to a maximum concentration of less than 0.1 times, preferably less than 0.01 times, more preferably less than 0.001 times, more particularly less than 0.0001 times, the critical micelle concentration of these organic emulsifiers in the water phase; this corresponds to a concentration of these organic emulsifiers, based on the total weight of the dispersion of the invention, of less than 10 wt %, preferably less than 2 wt %, more preferably less than 1 wt %, more particularly 0 wt %.

To produce the particle-stabilized Pickering emulsion E in the first step it is possible to use all of the techniques known to a skilled person for production of emulsions. It has emerged, however, that especially suitable emulsions for generating the particles P can be obtained in accordance with the following methods:

Method 1:
Initial introduction of a highly concentrated dispersion A, the volume initially introduced being made such that it comprises the total amount of required silica S and only a partial amount of water.
Slow metered addition of the total volume of mixture B with continual homogenizing by means, for example, of a high-speed stirrer, high-speed dissolver or a rotor-stator system.
Subsequent slow metered addition of the desired residual volume of water, optionally with continual homogenization by means, for example, of a high-speed stirrer, high-speed dissolver or a rotor-stator system.

Method 2:
Initial introduction of the dispersion A, the volume initially introduced being made such that it comprises the total amount of required silica S and water.
Slow metered addition of the total volume of mixture B with continual homogenization by means, for example, of a high-speed stirrer, high-speed dissolver, a rotor-stator system or by means of capillary emulsifier.

Method 3:
Initial introduction of the total volume of mixture B.
Slow metered addition of a highly concentrated dispersion A, with continual homogenization by means, for example, of a high-speed stirrer, high-speed dissolver or a rotor-stator system, the volume metered in being made such that it comprises the total amount of required silica S and only a partial amount of water.
Subsequent slow metered addition of the desired residual volume of water, optionally with continual homogenization by means, for example, of a high-speed stirrer, high-speed dissolver or a rotor-stator system.

Method 4:
Initial introduction of the total volume of mixture B.
Slow metered addition of the dispersion A with continual homogenization by means, for example, of a high-speed stirrer, high-speed dissolver or a rotor-stator system, the volume metered in being made such that it comprises the total amount of required silica S and water.

Method 5:
Initial introduction of the total volume of mixture B and of the dispersion A, the volume initially introduced being made such that it comprises the total amount of required silica S and water.
Joint homogenization by means, for example, of a high-speed stirrer, high-speed dissolver or a rotor-stator system.

Method 6:
Initial introduction of the total volume of mixture B and of a highly concentrated dispersion A, the volume initially introduced being made such that it comprises the total amount of required silica S and a partial amount of water.
Joint homogenization by means, for example, of a high-speed stirrer, high-speed dissolver or a rotor-stator system.
Subsequent slow metered addition of the desired residual volume of water, optionally with continual homogenization by means, for example, of a high-speed stirrer, high-speed dissolver or a rotor-stator system.

Preference is given to methods 1, 2, 5 and 6, with methods 2 and 5 being particularly preferred and method 5 especially preferred.

The homogenization takes place preferably in at least one method step for at least 30 seconds, preferably at least 1 minute.

The preparation of the dispersion A of the silica S in water, which forms the homogeneous phase in the emulsion of the invention, may take place in principle in accordance with the known methods for producing particle dispersions, such as incorporation using stirring elements with a high shearing action such as high-speed stirrers, high-speed dissolvers, rotor-stator systems, ultrasonic dispersers, or ballmills or bead mills.

The concentration of the silica S in the dispersion A here is between 1 and 80 wt %, preferably between 10 and 60 wt %, more preferably between 10 and 40 wt % and very preferably between 12 and 30 wt %.

In an optional method step, the Pickering emulsion E is diluted with water, optionally with continual homogenization by means, for example, of a high-speed stirrer, high-speed dissolver ora rotor-stator system.

The methods described may be carried out either in a continuous form or in a discontinuous form. The continuous form is preferred.

The temperature in the first step is between 0° C. and 80° C., preferably between 10° C. and 50° C., more preferably between 20° C. and 40° C.

The emulsifying operation may be carried out under atmospheric pressure, in other words at 900 to 1100 hPa, at elevated pressure or under reduced pressure. Operation under atmospheric pressure is preferred.

The concentration of the silica S in the three-phase mixture comprising dispersion A and mixture B from the first step here is between 1 and 80 wt %, preferably between 2 and 50 wt %, more preferably between 3 and 30 wt % and especially preferably between 4 and 20 wt %.

The concentration of the silicone elastomer composition X in the three-phase mixture comprising dispersion A and mixture B from the first step here is between 1 and 80 wt %, preferably between 20 and 76 wt %, more preferably between 40 and 72 wt % and especially preferably between 50 and 70 wt %.

The concentration of water in the three-phase mixture comprising dispersion A and mixture B from the first step here is between 5 and 80 wt %, preferably between 10 and 70 wt %, more preferably between 15 and 60 wt % and especially preferably between 20 and 40 wt %.

Starting from the above-described three-phase mixture, the particles P can be obtained in a second step by the following methods:

The three-phase mixture is diluted preferably by addition of water to a mass fraction of water with 50 wt % to 90 wt %, more preferably 40 wt % to 80 wt %.

In the second step the three-phase mixer is stirred preferably with a low shearing action, by means, for example, of a low-speed dissolver, rotor-stator or beam stirrer, until internal crosslinking of the particles P is complete, or shaken by means of suitable assemblies.

The duration of the second method step is preferably shorter than 120 h, being more preferably between 0 h to 48 h, very preferably 0.1 h to 24 h and, in one specific embodiment, 0.25 h to 12 h.

The three-phase mixture of dispersion A and mixture B from the first step may optionally be admixed with catalysts as stated above which accelerate and complete the crosslinking. This addition may be made before the preparation of the three-phase mixture, directly into the discontinuous phase or continuous phase; during the emulsification, or subsequently, into the completed three-phase mixture.

The amount used of any catalysts added is within the quantitative range typical for catalysts.

The reaction temperature during the crosslinking phase is between 0° C. and 100° C., preferably between 10° C. and 80° C. and more preferably between 15° C. and 60° C.

The reaction may optionally be carried out under an inert gas atmosphere such as nitrogen, argon or carbon dioxide. The oxygen fraction in that case is less than 15 vol %, preferably less than 10 vol % and more preferably less than 5 vol %.

The pH of the reaction mixture is between pH 10 and 1, preferably between pH 9 and 3, more preferably between pH 8 and 4 and, in one specific embodiment, between pH 7 and 5.

The three-phase mixture may optionally be admixed with water-soluble organic solvents such as alcohols such as methanol, ethanol or isopropanol or ketones such as acetone or MEK or ethers such as THF or others. These may be added in the first step or before or during the second step.

The three-phase mixture may optionally be admixed with dispersing assistants, protective colloids and/or surfactants. These may be added in the first step or before or during the second step.

The three-phase mixture comprises preferably less than 5 wt %, more preferably less than 1 wt %, more particularly less than 0.1 wt % of dispersing assistants, protective colloids and surfactants. In one specific embodiment the three-phase mixture is free from dispersing assistants, protective colloids and surfactants.

The three-phase mixture optionally comprises inorganic or organic electrolytes. These may be added either after the first step, during the second step, or after the end of the second step.

The ionic strength of the three-phase mixture in this case is between 0.01 mmol/l and 1 mol/l, preferably between 0.1 mmol/l and 500 mmol/l and more preferably between 0.5 mmol/l and 100 mmol/l.

The surface of the particles P may optionally be modified by treatment with reactive silanes or siloxanes. These may be added either directly after the end of the preparation of the Pickering emulsion in the first step, during the reaction phase, or after the end of the reaction phase in the second step, before the isolation of the particles P, or after the isolation of the particles in liquid or solid phase. This treatment should be conducted such that there is covalent, chemical attachment of the silane or siloxane to the particles. Corresponding techniques and methods are known to the skilled person.

The solids fraction of the particles P in the three-phase mixture consisting of the entirety of the solids used and of the polymerization product of the material capable of polyaddition, polycondensation or chain polymerization is between 5 wt % and 70 wt %, preferably between 10 wt % and 50 wt % and more preferably between 20 wt % and 40 wt %.

After the second step the three-phase mixture may optionally be stored, still with stirring. This may be accomplished by means of beam stirrers or anchor stirrers, for example.

In one preferred embodiment the particles P are isolated, preferably by sedimentation, filtration or centrifugation, more preferably by filtration or centrifugation, very preferably by centrifugation.

After they have been isolated, the particles P are washed preferably with a washing liquid preferably selected from fully demineralized water, methanol, ethanol and mixtures thereof.

In one preferred embodiment the particles P are isolated in powder form from the aqueous phase. This may be accomplished, for example, by means of filtration, sedimentation, centrifugation or by removal of the volatile constituents by drying in ovens or driers or by spray drying or by application of an appropriate reduced pressure.

Through spray drying it is possible to obtain very high fineness of the particles P without further working. Particles P dried by static drying tend to form loose agglomerates, which can be deagglomerated by suitable milling methods, by ballmill or air jet mill, for example.

Methods of Measurement
Solids content: 10 g of aqueous dispersion are admixed with the same amount of ethanol in a porcelain dish and evaporated to constant weight in an N₂-purged drying cabinet at 150° C. The mass ms of the dry residue gives the solids content, according to solids content/%=mₛ*100/10 g.
Mean particle diameter (×50):
The d₅₀ was determined using a Camsizer X2 from Retsch Technology (measurement principle: dynamic image analysis to ISO 13322-2, measurement range: 0.8 μm-30 mm, type of analysis: dry measurement of powders and granules, dispersing pressure=2 bar).
Carbon content % C determined by elemental analysis of carbon; combustion of the sample at above 1000° C. in an O₂ stream, detection and quantification of the resultant CO₂ by IR; instrument: LECO 244
Methanol number: for the determination of the methanol number, defined mixtures of water with methanol are prepared. In a separate experiment, these water-methanol mixtures are overlaid with the same volume of dried particles and shaken under defined conditions (for example, gentle shaking with the hand or with a tumble mixer for around 1 minute). Determinations are made of the water-alcohol mixture for which the particles just still do not sink in, and the water-alcohol mixture with higher alcohol content for which the particles just sink in. The latter methanol content in water gives the methanol number.
The kinematic viscosity is measured to DIN 53019 at 25° C.

In the examples below, unless otherwise indicated in each case, all quantities and percentages are by weight, all pressures are 0.10 MPa (abs) and all temperatures are 20° C.

### EXAMPLES

### Example 1: Preparation of an Aqueous Silica Dispersion A

1300 g of a partially hydrophobic pyrogenic silica having a residual silanol content of 71% and a carbon content of 0.95%, obtained by reacting a hydrophilic starting silica having a specific BET surface area of 200 m²/g (available under the name HDK® N20 from Wacker-Chemie GmbH, Munich) with dimethyldichlorosilane in accordance with EP 1433749 A1, are incorporated in portions with stirring into 5200 g of fully demineralized (FD) water in a Labo-Top planetary dissolver from PC Laborsystem, CH, at 650 rpm. Following complete addition of the silica, dispersion is continued for a further 60 min at 650 rpm. This gives a high-viscosity dispersion with a solids content of 20% and a pH of 4.2.

### Example 2: General Procedure for Mixing Dispersion A Comprising Silica S and Water with a Mixture B Using a Dissolver

Step 1: The silica dispersion described in Example 1 is weighed out into a suitable stirring vessel and agitated using a Labo-Top planetary dissolver from PC Laborsystem, CH, at 6000 rpm for 10 minutes. The viscosity of the dispersion goes down. Optionally FD water is added and mixed homogeneously. The mixed silicone oil component prepared according to one of Examples 5, 6 or 7 is added to the agitated silica dispersion and homogenized in the dissolver for 10 minutes at 6000 rpm with water coolant. During this time the temperature of the mixture ought not to rise above 35° C. The result is a white mass of high viscosity.

Step 2: The high-viscosity mass from method step 1 is diluted to 30% silicone oil content at 1000 rpm by addition of FD water in three equally sized portions. After each portion of FD water, stirring is carried out at 1000 rpm for 3 minutes. This gives a highly mobile, white O/W emulsion.

### Example 3: General Procedure for Mixing Dispersion A Comprising Silica S and Water with a Mixture B Using an Ultra-Turrax

Step 1: The silica dispersion described in Example 1 is weighed out into a suitable 1000 m/I stainless steel vessel and agitated using an Ultra-Turrax T50, at 10000 rpm for 10 minutes. The viscosity of the dispersion goes down. Optionally FD water is added and mixed homogeneously. The mixed silicone oil component prepared according to one of Examples 5, 6 or 7 is added to the agitated silica dispersion and then homogenized using the Ultra Turrax for 10 min at 10000 rpm with ice cooling. During this time the temperature of the mixture ought not to rise above 35° C. The result is a white mass of high viscosity.

Step 2: The high-viscosity mass from step 1 is diluted to 30% silicone oil content by addition of FD water in three equally sized portions. After each portion of FD water, stirring is carried out at 6000 rpm for 3 minutes. This gives a highly mobile, white O/W emulsion.

### Example 4: General Procedure for Producing Silica-Coated Silicone Elastomer Microparticles P of the Invention from Pickering Emulsions of Mixture B

250 g of the Pickering emulsion amenable to polyaddition, prepared according to Example 2 or Example 3, are admixed using a paddle stirrer at 200 rpm with 20 ppm of Karstedt catalyst (based on the amount of platinum) in the form of a 1 wt % solution in polydimethylsiloxane containing vinyl groups with a viscosity of 1000 mm²/s (25° C.), in which both chain ends are blocked with a dimethylvinylsilyl group, and the mixture is stirred at 80° C. for 24 hours. The result is a white, highly mobile dispersion. For isolation, the particles P are removed by filtration and dried in a drying cabinet at 80° C. for 24 hours. This gives a fine, white powder.

### Example 5: Silicon Resin-Reinforced Mixture B Amenable to Polyaddition

375 g of a vinyldimethylsiloxy-terminated polydimethylsiloxane having a viscosity of 1 000 mm²/s (25° C.) and 264 g of a vinyldimethylsiloxy-terminated polydimethylsiloxane having a viscosity of 20 000 mm²/s (25° C.) were mixed homogeneously using a paddle stirrer. Then 274 g of a silicone resin containing vinyl groups with the composition [Me₃SiO_{1/2}]_{26.65} [ViMe₂SiO_{1/2}]_{3.72} [SiO_{4/2}]_{42.78} [HO_{1/2}]_{1.02} [EtO_{1/2}]_{5.93} (molecular weight by SEC (eluent, toluene): Mw=5300 g/mol; Mn=2560 g/mol) were added and the mixture was stirred until dissolution was complete. The base mass thus obtained was mixed homogeneously with 114 g of a copolymer made up of dimethylsiloxy, methylhydrogensiloxy and trimethylsiloxy units, having a viscosity of 40 mm²/s at 25° C. and an SiH content of 0.40%.

### Example 6: Production of Silica-Coated, Silicone Resin-Reinforced Silicone Elastomer Particles P

320 g of the mixture B of the invention from Example 5 and 240 g of the aqueous silica dispersion A from Example 1 were emulsified as in Example 2. Subsequently, as in Example 4, pulverulent silicone elastomer particles P were produced, having a mean particle size of d50=3.4 □m.

### Example 7: Silica-Reinforced Mixture B Amenable to Polyaddition

Introduced initially in a commercial laboratory kneader were 917 g of a vinyldimethylsiloxy-terminated polydimethylsiloxane having a viscosity of 1000 mm²/s (25° C.), which were heated to 150° C. and admixed with 621 g of a hydrophobic pyrogenic silica having a specific surface area of 125 m²/g (measured by the BET method) and a carbon content of 1.6-2.0 wt %. This gave a high-viscosity mass, which was subsequently diluted with 618 g of the aforementioned polydimethylsiloxane. Kneading under reduced pressure (10 mbar) at 150° C. freed the resulting mass within an hour from water and excess residues of loading agent, especially volatile constituents. Then 123 g of a copolymer made up of dimethylsiloxy, methylhydrogensiloxy and trimethylsiloxy units, having a viscosity of 100 mm²/s at 25° C. and an SiH content of 0.47%, are added and homogeneously mixed.

### Example 8: Production of Silica-Coated, Silica-Reinforced Silicone Elastomer Particles P

156 g of the mixture B of the invention from Example 7 and 149 g of the aqueous silica dispersion A from Example 1 were emulsified as in Example 3. Subsequently, as in Example 4, pulverulent silicone elastomer particles P were produced, having a mean particle size of d50=12 □m.

### Comparative Example C1: Silicone Elastomer Composition Amenable to Polyaddition, Without Reinforcing Filler

1535 g of a polydimethylsiloxane containing vinyl groups with a viscosity of 1000 mm²/s (25° C.), in which both chain ends are blocked with a dimethylvinylsilyl group, were mixed homogeneously, using a paddle stirrer, with 123 g of a copolymer made up of dimethylsiloxy, methylhydrogensiloxy and trimethylsiloxy units with a viscosity of 100 mm²/s at 25° C. and an SiH content of 0.47%, without addition of a reinforcing additive.

### Comparative Example C2: Production of Silica-Ccoated, Silicone Elastomer Particles Without Reinforcing Filler

320 g of the silicone elastomer composition not in accordance with the invention, from comparative example C1, and 240 g of the aqueous silica dispersion from Example 1 were emulsified in accordance with Example 2. Subsequently, in accordance with Example 4, pulverulent silicone elastomer particles were produced, having a mean particle size of d50=18 □m.

### Comparative Example C3: Silicone Elastomer Composition Amenable to Polyaddition, Without Reinforcing Filler

479 g of a polydimethylsiloxane containing vinyl groups with a viscosity of 200 mm²/s (25° C.), in which both chain ends are blocked with a dimethylvinylsilyl group, were mixed homogeneously, using a paddle stirrer, with 21 wt % of a trimethylsilyl-terminated methylhydrosiloxane-dimethylsiloxane copolymer containing 0.73 wt % of Si-bonded hydrogen with a viscosity of 65 mm²/s (25° C.), without addition of a reinforcing additive.

### Comparative Example C4: Production of Silica-Coated, Silicone Elastomer Particles Without Reinforcing Filler

320 g of the silicone elastomer composition not in accordance with the invention, from comparative example C3, and 240 g of the aqueous silica dispersion from Example 1 were emulsified in accordance with Example 2. Subsequently, in accordance with Example 4, pulverulent silicone elastomer particles were produced, having a mean particle size of d50=9 □m.

### Example 9: Sensory Evaluation of the Particles P

The sensory evaluation of the silica-coated silicone elastomer particles P of the invention from Examples 6 and 8, and also of the particles not in accordance with the invention, from comparative examples C2 and C4, was carried out by a trained team of five testers.

For the evaluation, the testers washed their hands and lower arms with soap and water. On the lower arm, a circular test area having a diameter of 4 cm was drawn on for each sample, and 0.04 g of the respective particles each time was applied and sprayed.

The parameters evaluated by the testers were the sensation of silkiness during spreading and skinfeel after spreading of the powders, on a scale from 0 (poor) to 4 (very good). The results are set out in Table 1.

TABLE 1

| Example | Silkiness | Skin feel |
|---|---|---|
| Example 6 | 4 | 3 |
| Example 8 | 3 | 4 |
| Comparative example C2* | 1 | 2 |
| Comparative example C4* | 1 | 2 |

*not in accordance with the invention

### Example 9: Mechanical Integrity of the Particles P

In contrast to Example 8 the testers spread the particles on the skin under strong pressure. The results for the silica-coated silicone elastomer particles P of the invention from Examples 6 and 8 were unchanged, whereas the particles not in accordance with the invention, from comparative examples C2 and C4, formed lumps during spreading, this being undesirable in cosmetic applications.

TABLE 2

| Example | Silkiness | Skin feel |
|---|---|---|
| Example 6 | 4 | 3 |
| Example 8 | 3 | 4 |
| Comparative example C2* | 0 | 0 |
| Comparative example C4* | 0 | 0 |

*not in accordance with the invention

### Example 11: Evaluation of the Mechanical Strength

The silica-coated silicone elastomer particles P of the invention from Examples 6 and 8, and also the particles not in accordance with the invention, from comparative examples C2 and C4, were each admixed with 100 wt % of a polydimethylsiloxane of viscosity 2 mm²/s (25° C.), with stirring. The particles swell and absorb the silicone oil completely.

The swollen particles were then tested on the skin in analogy to Example 9.

Surprisingly it was found that the silica-coated silicone elastomer particles of the invention, from Examples 6 and 8, exhibit a very good velvety-silky lubricious skinfeel after spreading, whereas the skinfeel of the particles not in accordance with the invention, from comparative examples C2 and C4, was much waxier and more sluggish after spreading.

TABLE 3

| Example | Silkiness | Skin feel |
|---|---|---|
| Example 6 | 4 | 4 |
| Example 8 | 4 | 4 |
| Comparative example C2* | 3 | 0 |
| Comparative example C4* | 3 | 0 |

*not in accordance with the invention

1-11. (canceled)

12. Particles P, comprising:
wherein the particles P are composed of a core K comprising crosslinked silicone elastomer composition X and of a shell H of silica S; and
wherein the core K comprises a reinforcing filler F which is selected from pyrogenic or precipitated hydrophobic silicas having DIN 66131 BET surface areas of at least 50 m²/g and also from carbon blacks and activated carbons and silicone resins.

13. The particles P of claim 12, wherein the silicone elastomer composition X is addition-crosslinking and comprises
(A) at least one linear compound which contains radicals with aliphatic carbon-carbon multiple bonds,
(B) at least one linear organopolysiloxane compound with Si-bonded hydrogen atoms,
or, instead of (A) and (B),
(C) at least one linear organopolysiloxane compound which contains SiC-bonded radicals with aliphatic carbon-carbon multiple bonds and Si-bonded hydrogen atoms, and
(D) at least one hydrosilylation catalyst.

14. The particles P of claim 12, wherein the reinforcing filler F owing to surface treatment has a methanol number of greater than 40.

15. The particles P of claim 12, wherein the cores K comprise 5 to 200 parts by weight of reinforcing filler F per 100 parts by weight of the crosslinkable silicone elastomer composition X.

16. The particles P of claim 12, wherein the silica S is selected from pyrogenic or precipitated hydrophobic silicas having BET surface areas of at least 50 m²/g.

17. A method for producing particles P, comprising:
in a first step, mixing a dispersion A comprising silica S and water with a mixture B comprising crosslinkable silicone elastomer composition X to give a continuous phase containing water and a discontinuous phase containing crosslinkable silicone elastomer composition X;
in a second step, crosslinking the discontinuous phase to give the particles P;
wherein the mixture B and the discontinuous phase comprise a reinforcing filler F.

18. The method of claim 17, wherein the continuous phase comprises at least 80 wt % of water.

19. The method claim 17, wherein in the first step, the total volume of mixture B and of the dispersion A is introduced initially, the initially introduced volume being made such that it comprises the total amount of required silica S and water.

20. The method of claim 17, wherein, in the first step, a catalyst is added for crosslinking the crosslinkable silicone elastomer composition X.
